(19) United States
(12) Patent Application Publication
(10) Pub. No.: US 2009/0115189 A1
(43) Pub. Date: May 7, 2009

(54) POWER GENERATION DEVICE

(76) Inventor: HSIEN-MING LIN, Chupei City (TW)

Correspondence Address: LEONG C LEI, PMB # 1008, 1867 YGNACIO VALLEY ROAD, WALNUT CREEK, CA, 94598, US

(21) Appl. No.: 11/933,432

(22) Filed: Nov. 1, 2007

(51) Int. Cl. F03B 13/00; F03B 13/06

(52) U.S. Cl. 290/43; 290/54

(57) ABSTRACT

A power generation device includes a tower forming top and bottom reservoirs and a plurality of vertically arranged compartments between the top and bottom reservoirs. Each compartment is separated from the next lower compartment by a partition that defines a discharge opening. A rotary mechanism is arranged in each compartment and includes a rotary shaft carrying receptacles having openings set in different orientations. The shaft is coupled to a dynamo. Water is deposited in the top reservoir and is allowed to flow downward into the next lower compartment through the discharge opening for filling into the receptacles to cause rotation of the shaft, which in turn drives the dynamo to generate electrical power. Water flowing downward into the bottom reservoir can be selectively pumped back to the top reservoir for maintaining cyclic operation of the power generation device.

### BACKGROUND OF THE INVENTION

(a) Technical Field of the Invention

The present invention relates to a power generation device, and in particular to a power generation device that operates cyclically to continuously supply electrical power without external power to start the operation thereof.

(b) Description of the Prior Art

With the continuous consumption of the resources of the Earth, the resources are now gradually exhausted. In addition, the use of fossil energy causes increased greenhouse effect, which is now a severe problem to the human society. Thus, most of the countries around the world are devoted to the development of clean and renewable power sources for the supply of electrical power. The most commonly known power generation includes thermal power generation, hydraulic power generation, wind power generation, and unclear power generation. For thermal power generation, the operation of power generation is based on combustion of fossil fuel, which not only consumes the valuable resources of the Earth, but is also related to the emission of greenhouse gases.

For hydraulic power generation, to be commercially feasible, a large-sized water mill is required. The water mill is often set in multiple groups and requires a strong water flow impact to ensure proper rotation of the water mill in order to drive a power generator coupled to the water mill. This is of high costs. Also, the arrangement of the water mill is subject to cons tint of location, where sufficient water flow or hydraulic energy is available.

As to wind power generation, a high tower and a large-size windmill rotatably supported at the top of the tower are often required to extract kinetic energy from strong blows that hit and rotate the windmill to in turn drive a power generator coupled to the windmill. The construction of the windmill is of high costs and is subjected to constraint of location where continuous and generally non-interrupted blows exist. In other words, wind power generation is not suitable for areas where no blow is generally available.

Nuclear power generation is a clean power source in the respect of greenhouse effect. However, nuclear contamination is a potential severe problem to the area where a nuclear power plant is located. The future of the nuclear power generation is still of debate and is continuously argued by the environment-protectionists.

In view of these drawbacks of the currently used power generation methods, the present invention is aimed to provide an environment-conservative and endlessly operable power generation system that overcomes the drawbacks of the conventional methods and devices.

### SUMMARY OF THE INVENTION

The primary purpose of the present invention is to provide a power generation device, which is operable in a cyclic manner without a supply of an external starting power to continuously supply electrical power.

In accordance with the present invention, a power generation device comprises a tower having a top floor and a bottom floor each being provide with a water reservoir. A water pumping device is arranged in the bottom floor reservoir and is coupled to a piping system that extends to the top floor reservoir. An interior space of the tower between the top and bottom floor are divided into a plurality of vertically arranged compartments by substantially horizontal partitions each functioning as a bottom of the respective compartment and defining a discharge opening. A rotary mechanism is arranged in each compartment and supported on the bottom of the compartment and comprises a plurality of receptacles having openings set at different angular positions. The rotary mechanism has a rotary shaft that is coupled to a spindle of a power generator unit associated with the respective compartment. Thus, when the top floor reservoir is filled up with water, the water is allowed to flow trough a discharge opening formed in a bottom of the top floor reservoir into the compartment right next below the top floor reservoir and then sequentially to the next reservoirs through the discharge openings of the respective partitions. The water flowing into each compartment is sequentially filled into the receptacles of the rotary mechanism, and due to the gravity of the water filled into the receptacles, the rotary shaft of the rotary mechanism is caused to rotate in a predetermined direction, which in turn drives the spindle of the power generator unit to induce electrical power. The water flowing through all the compartments is eventually filled into the bottom floor reservoir and is then pumped by the water pumping device to circulate back to the top floor reservoir for cyclic operation of continuous supply of electrical power.

In the power generation device of the present invention, each partition that forms the bottom of each compartment of the tower is set in a concave configuration with the discharge opening at the lowest location so that the portions of the partition surrounding the discharge opening are set in an upward inclined manner. This facilitates guiding water to the discharge opening.

In the power generation device of the present invention, a main conduit is arranged outside the tower and is connected to an external water supply source. A branch tube extends from the main conduit to each of the compartments. Thus, when the water circulated in the tower is caused to diminish by any factor, such as evaporation, supplement of water can be made through the main conduit connected to the external water supply source.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic vertical section of a power generation device constructed in accordance with the present invention;

FIG. 1A is also a schematic vertical section of the power generation device of the present invention but taken in different direction;

FIG. 2 is a perspective view of a rotary mechanism of the power generation device of the present invention;

FIG. 3 is a schematic view illustrating the arrangement of four receptacles of the rotary mechanism;

FIG. 4 is a schematic vertical section of the power generation device illustrating the operation thereof;

FIG. 5 is a perspective view of the rotary mechanism, illustrating the operation thereof for driving a power generator unit; and

FIG. 7 is a schematic vertical section of the power generation device illustrating supplement of water from an external source.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illusion for implementing exemplary embodiments of the invention. Various changes to the described embodiments may be made in the function and arrangement of the elements described without departing from the scope of the invention as set forth in the appended claims.

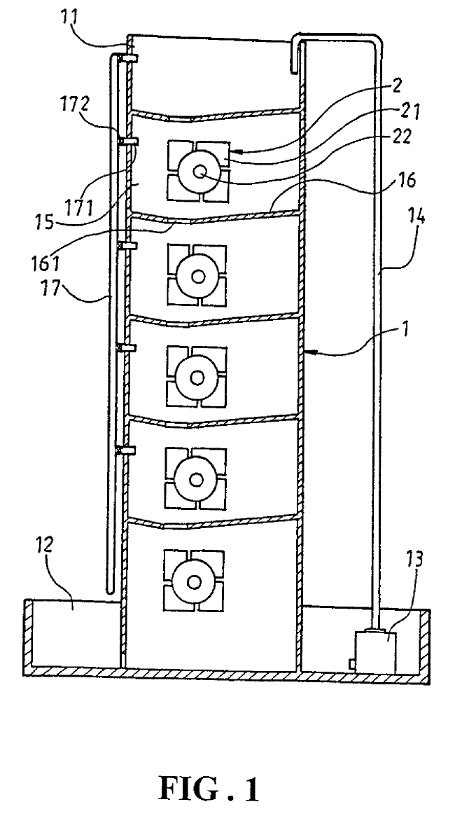

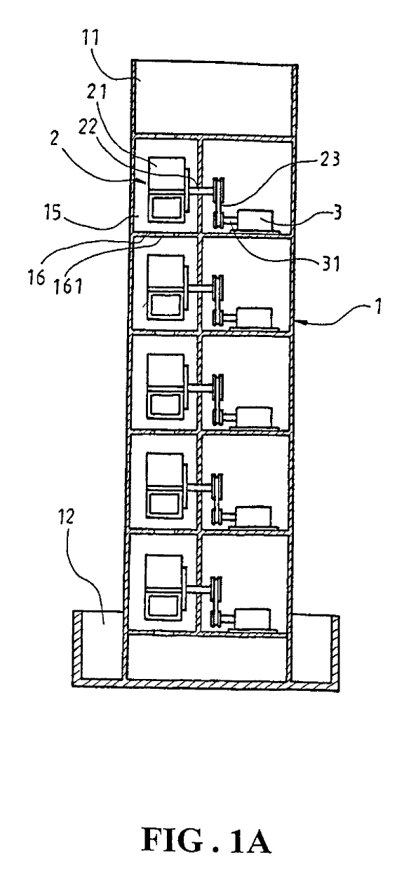

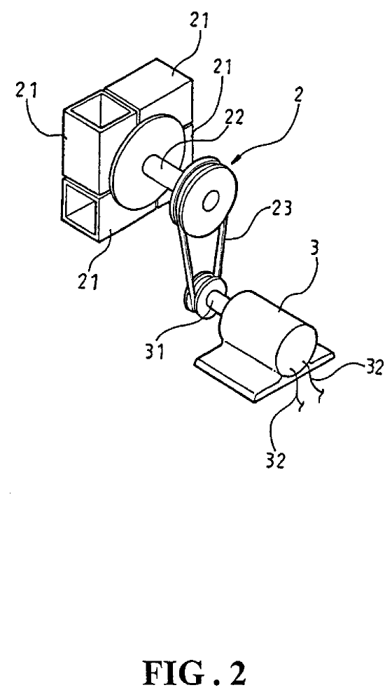

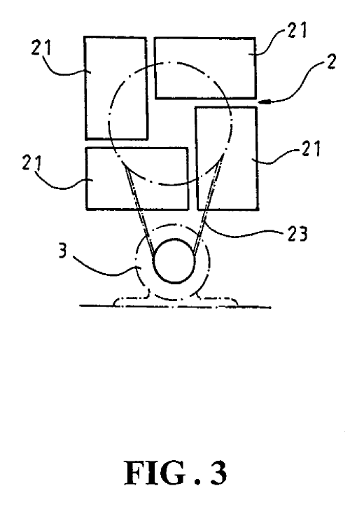

With reference to the drawings and in particular to FIGS. 1, 1A, 2, and 3, a power generation device constructed in accordance with the present invention comprises an upright tower, generally designated at 1, having a top end forming a top floor reservoir 11 and comprising a bottom floor reservoir 12 formed at a bottom or root of the tower 1. A water pumping device 13 is arranged in the bottom floor reservoir 12 and is connected to a pipe 14 that extends upward to the top floor reservoir 11.

The tower 1 defines an interior space between the top floor reservoir 11 and the bottom floor reservoir 12. The interior space forms at least one compartment 15 vertically arranged between the top floor reservoir 11 and the bottom floor reservoir 12. Preferably and as shown in the drawings, the interior space is divided into a plurality of vertically arranged compartments 15 between the top floor reservoir 11 and the bottom floor reservoir 12. The compartments 15 are delimited by substantially horizontal partitions 16 that are spaced vertically to form the compartments 15. Each partition 16 serves as a bottom of the respective compartment 15 and forms a discharge opening 161 that communicates the next lower compartment 15. The partition 16 is set in a concave form having a lowest point where the discharge opening 161 is formed. Thus, portions of the partition 16 that surround the discharge opening 161 are inclined upward in a direction away from the discharge opening 161.

In each compartment 15, a rotary mechanism 2 is mounted on the bottom partition 16 thereof. The rotary mechanism 2 is composed of a plurality of receptacles 21, which is four in the embodiment illustrated, each having an opening directed to different angular orientation. Thus, the receptacles 21 of the rotary mechanism 2 are arranged at different angles. The rotary mechanism 2 comprises a rotary shaft 22 that is preferably set at a common center of the receptacles 21 and fixed with the receptacles 21. The rotary shaft 22 is coupled to a spindle 31 of a power generator unit 3, such as a dynamo, via a transmission belt 23 and associated pulleys (not labeled).

Arranged outside the tower 1 is a water conduit 17 that communicates an external water supply source, such as city water supply. The water conduit 17 comprises a plurality of branch tubes 171 each in communication with the conduit 17 and extending into each compartment 15 and each equipped with a control valve 172.

With the components/members/mechanisms described above, a power generation device can be formed, which is set at, for example, a downstream location of a river, a sea water introduction channel in a seashore, or simply located below a large reservoir for rainwater, so that the top floor reservoir 11 can be continuously supplied with water. And as described above, the water filled into the top floor reservoir 11 is allowed to flow through a discharge opening (not labeled) formed in a bottom of the top floor reservoir 11 into the compartment 15 right next below the top floor reservoir 11 and then sequentially to the next reservoirs 15 through the discharge openings 161 of the respective partitions 16. The water flowing into each compartment 15 is sequentially filled into the receptacles 21 of the rotary mechanism 2, and due to the gravity of the water filled into the receptacles 21, the rotary shaft 22 of the rotary mechanism 2 is caused to rotate in a predetermined direction, which in turn drives the spindle 31 of the power generator unit 3 to generate electrical power. The electrical power so generated is transmitted trough electrical wires 32 that are connected to the power generator unit 3 to a power accumulation device for storage and subsequent use. The water flowing through all the compartments 15 is eventually filled into the bottom floor reservoir 12 and is then pumped by the water pumping device 13 to circulate back to the top floor reservoir 11 for cyclic operation of continuous supply of electrical power.

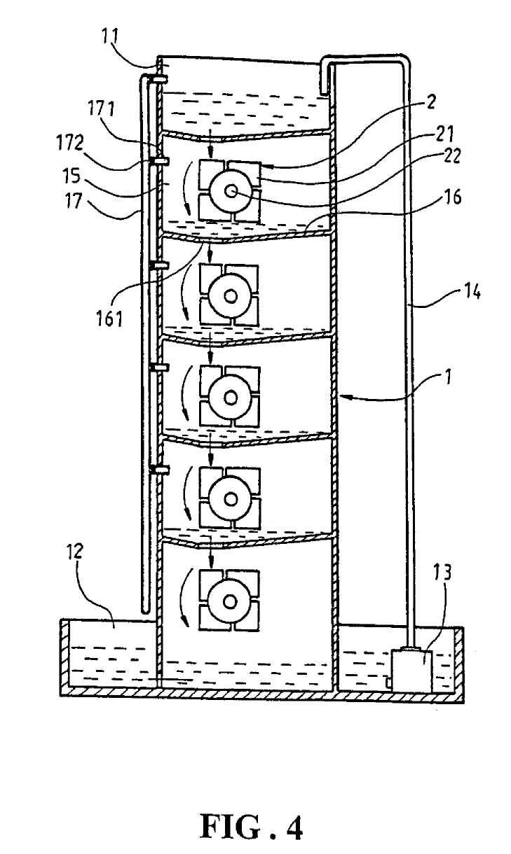

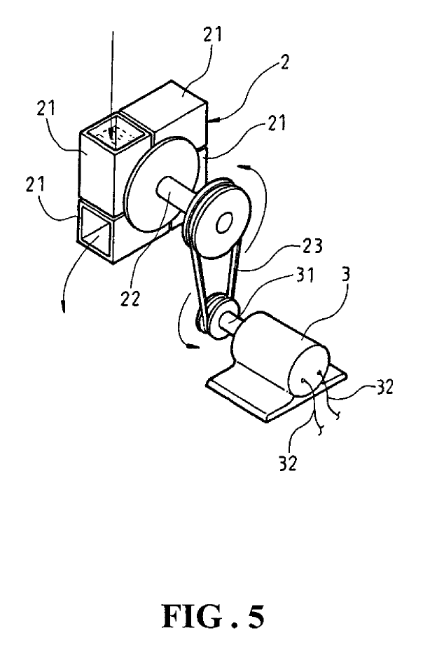

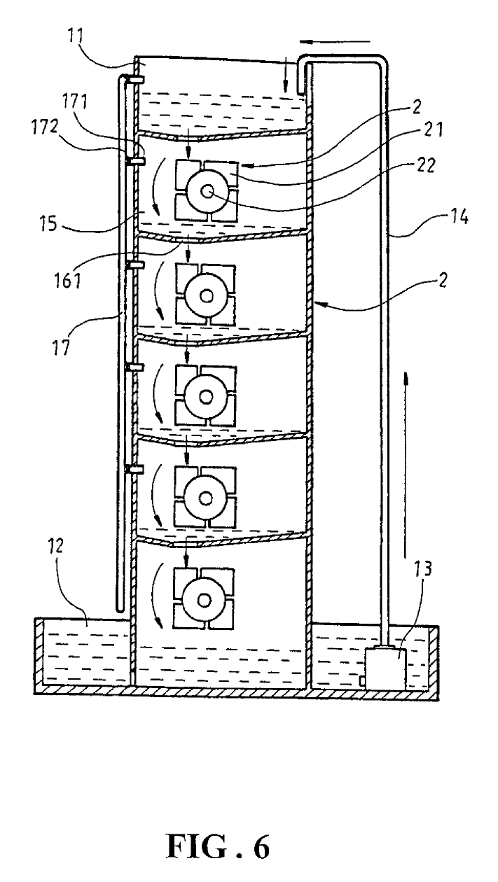

Also referring to FIGS. 4 and 5, in a practical application, the power generation device of the present invention is set at a downstream location of a river, a sea water introduction channel in seashore, or below a large reservoir for rainwater, to allow the top floor reservoir 11 to be continuously supplied with water. The water then flows downward through the discharge opening 161 of each partition 16 of the compartment 15. Due to the concave configuration of the partition 16, the water is guided toward the discharge opening 161 thereof for flowing toward the receptacles 21 of the rotary mechanism 2 of the next low compartment 15. The weight of the water filled into the receptacles 21 of the rotary mechanism 2 causes the rotary mechanism 2 to rotate in a predetermined direction, which in turn drives the spindle 31 of the power generator unit 3 through the transmission belt 23, as well as the associated pulleys. Electrical current is thus induced in wire windings inside the power generator unit 3 and the electrical power so generated is transmitted through the electrical wires 32 that are connected to the power generator unit 3 to the power accumulation device for storage and subsequent use by other electrical appliances or devices.

Also referring to FIG. 6, during the process that the water flows through all compartments 15 via the discharge openings 161 of the partitions 16 and fills into the bottom floor reservoir 12, when the supply of waters to the top floor reservoir 11 is interrupted or insufficient caused by any reason, the pumping device 13 can be actuated to temporarily pump the water filled into the bottom floor reservoir 12 through the pipe 14 back to the top floor reservoir 11 to maintain the circulation of water flow and ensure non-interrupted operation of the power generator units 3 for the continuous supply of electrical power until normal and sufficient supplement of external water source to the top floor reservoir 11 is resumed, at which time the pumping device 13 is shut off.

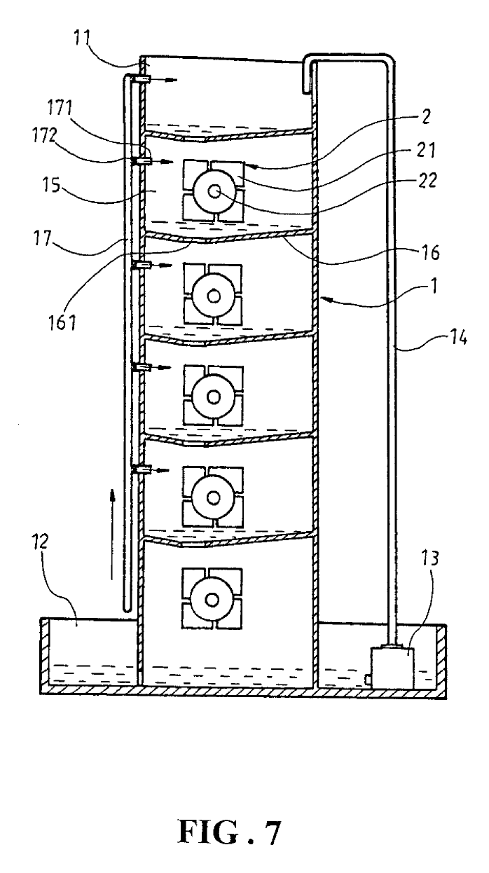

Also referring to FIG. 7, the conduit 17 arranged outside the tower 1 is connected to an external water supply source and comprises the branch tubes 171 that extend to the compartments 15 respectively. The branch tubes 171 are provided with the control valves 172 so that when the amount of water that is in the circulation through the tower 1 is reduced by any factor, such as evaporation, or when the supply of water to the top floor reservoir 11 is interrupted or insufficient, the control valves 172 are open to supplement water from the external water supply source to the tower 1 for maintaining normal operation of the power generation device.

To conclude, the present invention provides a power generation device that comprises an upright tower in which compartments are arranged vertically and each include a rotary mechanism comprised of multiple receptacles to provide rotary mechanical energy to dynamos, which convert the mechanical energy into electrical power. The power generation device can be put in operation without the supply of external power to provide a continuous supply of electrical power in a cyclic operation.

Although the present invention has been described with reference to the preferred embodiment and practical applications thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed clam, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power generation device comprising:
a vertical tower comprising a top and a bottom respectively forming a top floor reservoir having a bottom forming a discharge opening and a bottom floor reservoir and an interior space between the top and bottom and forming at least one compartment arranged in a vertical direction between the top floor reservoir and the bottom floor reservoir, a substantially horizontal partition being arranged in the interior space to serve as a bottom of each compartment, each partition forming a discharge opening; and
a rotary mechanism arranged in each compartment and comprising a plurality of receptacles having openings arranged at different angles and a rotary shaft fixed to the receptacles and operatively coupled to a spindle of a power generator unit;
wherein the top floor reservoir is adapted to receive a supply of water therein and the water is allowed to flow downward to a next lower one of the compartments rough the discharge opening for filling into the receptacles of the rotary mechanism of the said next lower one compartment so that gravity of the water filled into the receptacles causes the rotary mechanism to rotate in a predetermined direction and thus driving the spindle of the power generator unit to generate electrical power.

2. The power generation device as claimed in claim 1 further comprising a water pumping device arranged in the bottom floor reservoir and connected to a pipe that extends to the top floor reservoir whereby when the water supply to the top floor reservoir is interrupted or insufficient, the water pumping device is selectively aced to pump water contained in the bottom floor reservoir to the top floor reservoir to maintain water downward flowing through the compartment.

3. The power generation device as claimed in claim 1, wherein the partition of each compartment is of a concave configuration having a lowest location where the discharge opening is formed, portions of the partition surrounding the discharge opening are inclined upward in a direction away from the discharge opening in order to facilitate guiding water to the discharge opening.

4. The power generation device as claimed in claim 1 further comprising a water conduit arranged outside the tower and adapted to connect to an external water supply source, the water conduit comprising and in communication with a branch extending to each compartment to selectively carry out supplementary of water to the tower.

5. The power generation device as claimed in claim 1, wherein the power generator unit comprises dynamo.
